(19) United States
(12) Patent Application Publication
(10) Pub. No.: US 2026/0148735 A1
(43) Pub. Date: May 28, 2026

(54) METHOD FOR PROCESSING SPEECH SIGNAL, ELECTRONIC DEVICE FOR PERFORMING SAID METHOD, AND RECORDING MEDIUM

(71) Applicant: SAMSUNG ELECTRONICS CO., LTD., Suwon-si (KR)

(72) Inventors: Gilho Lee, Suwon-si (KR); Jungin Lee, Suwon-si (KR); Seokyeong Jeong, Suwon-si (KR)

(73) Assignee: SAMSUNG ELECTRONICS CO., LTD., Suwon-si (KR)

(21) Appl. No.: 19/456,450

(22) Filed: Jan. 22, 2026

Related U.S. Application Data
(63) Continuation of application No. PCT/KR2024/010557, filed on Jul. 22, 2024.

(30) Foreign Application Priority Data
Jul. 24, 2023 (KR) 10-2023-0096385
Sep. 26, 2023 (KR) 10-2023-0129478

(51) Int. Cl. G10L 15/01; G10L 15/22

(52) U.S. Cl. CPC G10L 15/01; G10L 15/22; G10L 2015/223

(57) ABSTRACT

An electronic device includes one or more processors and memory storing instructions. The instructions, when executed by the one or more processors individually or collectively, cause the electronic device to store a recognition result of a first utterance received from a user; receive a second utterance from the user within a period after receiving the first utterance; determine a first similarity between the recognition result of the first utterance and a recognition result of the second utterance; determine parameters for correcting the recognition result of the second utterance based on the first similarity being greater than or equal to a threshold; and correct the recognition result of the second utterance based on the parameters.

### CROSS-REFERENCE TO RELATED APPLICATION(S)

This application is a bypass continuation application of International Patent Application No. PCT/KR 2024/010557, filed on Jul. 22, 2024, which claims priority to and is based on Korean Patent Application No. 10-2023-0096385, filed on Jul. 24, 2023, and Korean Patent Application No. 10-2023-0129478, filed on Sep. 26, 2023, the disclosures of which are incorporated herein in their entireties by reference.

### 1. FIELD

The following description relates to a method for processing a speech signal and an electronic device for performing said method, and a recording medium.

### 2. DESCRIPTION OF RELATED ART

Although speech recognition performance has improved and been widely adopted as an interface in various products and services, accurate recognition of human speech remains challenging.

To improve recognition accuracy, an intent of a speaker may be identified, and additional information corresponding to the identified intent may be used. However, even when the identified intent of the speaker and the additional information are used, there are cases in which a user's utterance is not accurately recognized in speech recognition.

When a user's utterance is not accurately recognized, the user may utter the utterance in a different manner, such as speaking more loudly or speaking more slowly.

The above information may be presented as the related art to help with the understanding of the disclosure. No arguments or decisions are raised to whether any of the above description is applicable as the prior art related to the present disclosure.

### SUMMARY

According to one or more embodiments, an electronic device may include one or more processors; and a memory storing instructions. The instructions, wherein the instructions, when executed by the one or more processors individually or collectively, may cause the electronic device to store a recognition result of a first utterance received from a user; receive a second utterance from the user within a period after receiving the first utterance; determine a first similarity between the recognition result of the first utterance and a recognition result of the second utterance; determine parameters for correcting the recognition result of the second utterance based on the first similarity being greater than or equal to a threshold; and correct the recognition result of the second utterance based on the parameters.

According to one or more embodiments, a method for processing a speech signal may include storing a recognition result of a first utterance received from a user; receiving a second utterance from the user within a period after receiving the first utterance; determining a first similarity between the recognition result of the first utterance and a recognition result of the second utterance; determining parameters for correcting the recognition result of the second utterance based on the first similarity being greater than or equal to a threshold; and correcting the recognition result of the second utterance based on the parameters.

According to one or more embodiments, a non-transitory computer-readable storage medium having stored thereon instructions that, when executed by one or more processors of an electronic device individually or collectively, may cause the electronic device to store a recognition result of a first utterance received from a user; receive a second utterance from the user within a period after receiving the first utterance; determine a first similarity between the recognition result of the first utterance and a recognition result of the second utterance; determine parameters for correcting the recognition result of the second utterance based on the first similarity being greater than or equal to a threshold; and correct the recognition result of the second utterance based on the parameters.

### BRIEF DESCRIPTION OF DRAWINGS

The above and other aspects, features, and advantages of one or more embodiments of the present disclosure will be more apparent from the following description taken in conjunction with the accompanying drawings, in which:

FIG. 1 is a block diagram illustrating an electronic device 101 in a network environment 100 according to one or more embodiments;

FIG. 2 is a block diagram illustrating an integrated intelligence system according to one or more embodiments;

FIG. 3 is a diagram illustrating a form in which relationship information regarding relationships between concepts and actions is stored in a DB, according to one or more embodiments;

FIG. 4 is a diagram illustrating a screen of a user terminal processing a received speech input through an intelligent app, according to one or more embodiments;

FIG. 5 is a schematic block diagram illustrating an electronic device 101 according to one or more embodiments;

FIG. 6 is a flowchart illustrating an operation of a speech signal processing method according to one or more embodiments;

FIG. 7 is a flowchart illustrating an operation of determining a recognition result of a second utterance using candidate recognition results of the second utterance according to one or more embodiments;

FIG. 8 is a flowchart illustrating an operation of a speech signal processing method according to one or more embodiments;

FIG. 9 is a diagram illustrating a screen on which an electronic device 101 (e.g., the electronic device 101 of FIGS. 1 and 2) according to one or more embodiments;

FIG. 10 is a diagram illustrating an operation of an electronic device (e.g., the electronic device 101 of FIGS. 1 and 5) according to one or more embodiments; and.

FIG. 11 is a diagram illustrating an operation of an electronic device (e.g., the electronic device 101 of FIGS. 1 and 5) according to one or more embodiments.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

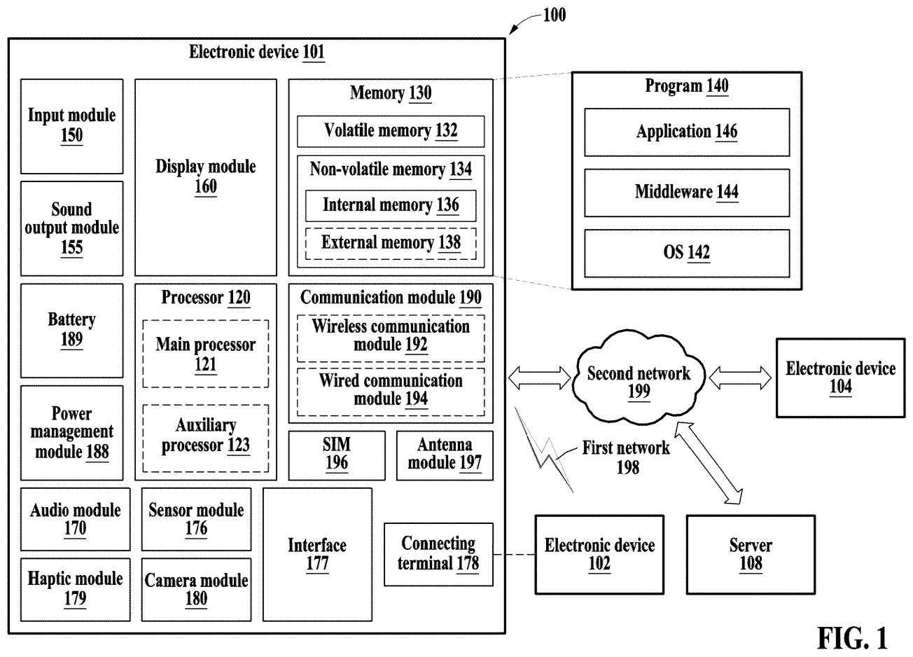

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120 and may perform various data processing or computations. According to an embodiment, as at least a part of data processing or computations, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specifically for artificial intelligence model processing. An artificial intelligence model may be generated by machine learning. The machine learning may be performed by, for example, the electronic device 101, in which AI is performed, or performed via a separate server (e.g., the server 108). Learning algorithms may include, but are not limited to, for example, supervised learning, unsupervised learning, semi-supervised learning, or reinforcement learning. The AI model may be based on a pre-trained model. The AI model may be updated using various fine-tuning techniques (e.g., parameter efficient fine-tuning). The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, transformer neural network, or a combination of two or more thereof, but examples are not limited thereto. The AI model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134. The memory 130 may include non-transitory machine-readable (e.g., computer-readable) storage medium.

The program 140 may be stored as software in the memory 130 and may include, for example, an operating system (OS) 142, middleware 144, or an application 146.

The input module 150 may receive, from outside (e.g., a user) the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a control circuit for controlling a display, a hologram device, or a projector and control circuitry to control a corresponding one of the display, the hologram device, or the projector. According to an embodiment, the display module 160 may include a touch sensor adapted to detect a touch, or a pressure sensor adapted to measure the intensity of force incurred by the touch.

The audio module 170 may convert a sound into an electric signal or vice versa. According to one or more embodiments, the audio module 170 may obtain the sound via the input module 150 or output the sound via the sound output module 155 or an external electronic device (e.g., the electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101 and generate an electric signal or data value corresponding to the detected state. According to one or more embodiments, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used by the electronic device 101 to couple with the external electronic device (e.g., the electronic device 102) directly (e.g., by wire) or wirelessly. According to one or more embodiments, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may physically connect to an external electronic device (e.g., the electronic device 102). According to one or more embodiments, the connecting terminal 178 may include, for example, an HDMI connector, a USB connector, an SD card connector, or an audio connector (e.g., a headphones connector).

The haptic module 179 may convert an electric signal into a mechanical stimulus (e.g., a vibration or a movement) or an electrical stimulus, which may be recognized by a user via their tactile sensation or kinesthetic sensation. According to one or more embodiments, the haptic module 179 may include, for example, a motor, a piezoelectric element, or an electric stimulator.

The camera module 180 may capture a still image and moving images. According to one or more embodiments, the camera module 180 may include one or more lenses, image sensors, ISPs, or flashes.

The power management module 188 may manage power supplied to the electronic device 101. According to one or more embodiments, the power management module 188 may be implemented as, for example, at least a part of a power management integrated circuit (PMIC).

The battery 189 may supply power to at least one component of the electronic device 101. According to one or more embodiments, the battery 189 may include, for example, a primary cell, which is not rechargeable, a secondary cell, which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., an AP) and that support direct (e.g., wired) communication or wireless communication. According to one embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device, for example, the electronic device 104, via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip) or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, for example, a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beamforming, or a large-scale antenna. The wireless communication module 192 may support various requirements specified in the electronic device 101, an external electronic device (e.g., the electronic device 104), or a network system (e.g., the second network 199). According to one or more embodiments, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to one or more embodiments, the antenna module 197 may include an antenna including a radiating element including a conductive material or a conductive pattern formed in or on a substrate (e.g., a printed circuit board (PCB)). According to one or more embodiments, the antenna module 197 may include a plurality of antennas (e.g., an antenna array). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to one or more embodiments, another component (e.g., a radio frequency integrated circuit (RFIC)) other than the radiating element may be additionally formed as a part of the antenna module 197.

According to one or more embodiments, the antenna module 197 may form a mmWave antenna module. According to one or more embodiments, the mmWave antenna module may include a PCB, an RFIC on a first surface (e.g., the bottom surface) of the PCB, or adjacent to the first surface of the PCB and capable of supporting a designated high-frequency band (e.g., a mmWave band), and a plurality of antennas (e.g., array antennas) arranged on a second surface (e.g., the top or a side surface) of the PCB, or adjacent to the second surface of the PCB and capable of transmitting or receiving signals of the designated high-frequency band.

At least some of the above-described components may be coupled mutually and exchange signals (e.g., commands or data) therebetween via an inter-peripheral communication scheme (e.g., a bus, general purpose input and output (GPIO), serial peripheral interface (SPI), or mobile industry processor interface (MIPI)).

According to one or more embodiments, commands or data may be transmitted or received between the electronic device 101 and the external electronic device (e.g., the electronic device 104) via the server 108 coupled with the second network 199. Each of the external electronic devices (e.g., the electronic device 102 or 104) may be a device of the same type as or a different type from the electronic device 101. According to one or more embodiments, all or some of operations to be executed by the electronic device 101 may be executed by one or more external electronic devices (e.g., the electronic devices 102 and 104 and the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or service. The one or more external electronic devices receiving the request may perform the at least part of the function or service, or an additional function or an additional service related to the request and may transfer a result of the performance to the electronic device 101. The electronic device 101 may provide the result, with or without further processing the result, as at least part of a response to the request. To that end, cloud computing, distributed computing, mobile edge computing (MEC), or client-server computing technology may be used, for example. The electronic device 101 may provide ultra-low-latency services using, e.g., distributed computing or MEC. In one or more embodiments, the external electronic device (e.g., the electronic device 104) may include an Internet-of-things (IoT) device. The server 108 may be an intelligent server using machine learning and/or a neural network. According to one or more embodiments, the external electronic device (e.g., the electronic device 104) or the server 108 may be included in the second network 199. The electronic device 101 may be applied to intelligent services (e.g., smart home, smart city, smart car, or healthcare) based on 5G communication technology or IoT-related technology.

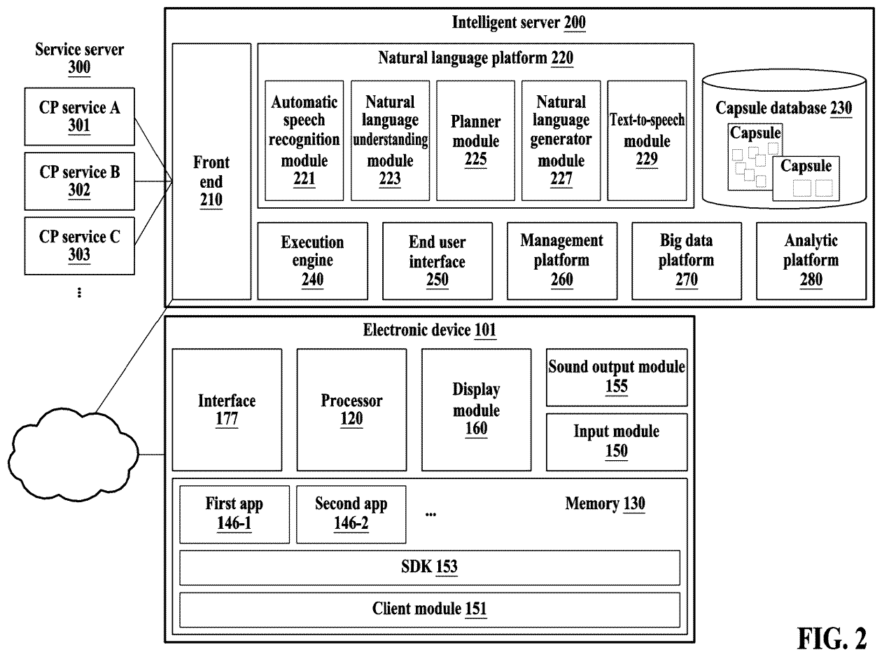

FIG. 2 is a block diagram illustrating an integrated intelligence system according to one or more embodiments.

Referring to FIG. 2, an integrated intelligence system of one or more embodiments may include the electronic device 101, an intelligent server 200 (e.g., the server 108 of FIG. 1), and a service server 300 (e.g., the server 108 of FIG. 1).

The electronic device 101 may be a terminal device (or an electronic device) connectable to the Internet, and may be, for example, a mobile phone, a smartphone, a personal digital assistant (PDA), a notebook computer, a TV, a white home appliance, a wearable device, a head-mounted display (HMD), or a smart speaker.

According to the illustrated embodiment, the electronic device 101 may include the interface 177, the input module 150, the sound output module 155, the display module 160, the memory 130, or the processor 120. The components listed above may be operationally or electrically connected to each other.

The interface 177 may be connected to an external device and configured to transmit and receive data to and from the external device. The input module 150 may receive a sound (e.g., a user utterance) and convert the sound into an electric signal. The sound output module 155 may output an electric signal as a sound (e.g., a speech).

The display module 160 may be configured to display an image or video. The display module 160 of one or more embodiments may also display a graphical user interface (GUI) of an app (or an application program) being executed. The display module 160 of one or more embodiments may receive a touch input through a touch sensor. For example, the display module 160 may receive a text input through the touch sensor in an on-screen keyboard area displayed in the display module 160.

The memory 130 of one or more embodiments may store a client module 151, a software development kit (SDK) 153, and a plurality of apps 146. The client module 151 and the SDK 153 may configure a framework (or a solution program) for performing general-purpose functions. In addition, the client module 151 or the SDK 153 may configure a framework for processing a user input (e.g., a speech input, a text input, or a touch input).

The plurality of apps 146 stored in the memory 130 of one or more embodiments may be programs for performing designated functions. According to one or more embodiments, the plurality of apps 146 may include a first app 146-1 and a second app 146-2. According to one or more embodiments, each of the plurality of apps 146 may include a plurality of actions for performing a designated function. For example, the apps may include an alarm app, a messaging app, and/or a scheduling app. The plurality of apps 146 may be executed by the processor 120 to sequentially execute at least a portion of the plurality of actions.

The processor 120 may control the overall operation of the electronic device 101. For example, the processor 120 may be electrically connected to the interface 177, the input module 150, the sound output module 155, and the display module 160 to perform a designated operation.

The processor 120 of one or more embodiments may also perform the designated function by executing the program stored in the memory 130. For example, the processor 120 may execute at least one of the client module 151 or the SDK 153 to perform the following operation for processing a user input. The processor 120 may control the actions of the plurality of apps 146 through, for example, the SDK 153. The following operation, which is the operation of the client module 151 or the SDK 153, may be performed by the processor 120.

The client module 151 of one or more embodiments may receive a user input. For example, the client module 151 may receive a speech signal corresponding to a user utterance sensed through the input module 150. Alternatively, the client module 151 may receive a touch input sensed through the display module 160. As still another example, the client module 151 may receive a text input sensed through a keyboard or an on-screen keyboard. In addition, the client module 151 may receive various types of user inputs sensed through an input module included in the electronic device 101 or an input module connected to the electronic device 101. The client module 151 may transmit the received user input to the intelligent server 200. The client module 151 may transmit state information of the electronic device 101 together with the received user input to the intelligent server 200. The state information may be, for example, execution state information of an app.

The client module 151 of one or more embodiments may receive a result corresponding to the received user input. For example, when the intelligent server 200 is capable of calculating a result corresponding to the received user input, the client module 151 may receive the result corresponding to the received speech input. The client module 151 may display the received result on the display module 160. Additionally, the client module 151 may output the received result in an audio form through the sound output module 155.

The client module 151 of one or more embodiments may receive a plan corresponding to the received user input. The client module 151 may display results of executing a plurality of actions of an app according to the plan on the display module 160. For example, the client module 151 may sequentially display the results of executing the plurality of actions on the display and output the results in an audio form through the sound output module 155. In another example, the electronic device 101 may display only a portion of the results of executing the plurality of actions (e.g., a result of the last action) on the display module 160 and output the portion of the results in an audio form through the sound output module 155.

According to one or more embodiments, the client module 151 may receive a request for obtaining information necessary for calculating a result corresponding to the user input from the intelligent server 200. According to one or more embodiments, the client module 151 may transmit the necessary information to the intelligent server 200 in response to the request.

The client module 151 of one or more embodiments may transmit information regarding the results of executing the plurality of actions according to the plan to the intelligent server 200. The intelligent server 200 may confirm that the received user input is correctly processed using the information regarding the results.

The client module 151 may include a speech recognition module. According to one or more embodiments, the client module 151 may recognize a speech input for performing a limited function through the speech recognition module. For example, the client module 151 may execute an intelligent app for processing a speech input to perform an organic operation through a designated input (e.g., Wake up!).

The intelligent server 200 may receive information related to a user speech input from the electronic device 101 through a communication network. According to one or more embodiments, the intelligent server 200 may change data related to the received speech input into text data. According to one or more embodiments, the intelligent server 200 may generate a plan for performing a task corresponding to the user speech input based on the text data.

According to one or more embodiments, the plan may be generated by an artificial intelligence (AI) system. The artificial intelligence system may be a rule-based system or a neural network-based system (e.g., a feedforward neural network (FNN) or a recurrent neural network (RNN)). Alternatively, the artificial intelligence system may be a combination thereof or other artificial intelligence systems. According to one or more embodiments, the plan may be selected from a set of pre-defined plans or may be generated in real time in response to a user request. For example, the AI system may select at least one plan from the pre-defined plans.

The intelligent server 200 of one or more embodiments may transmit a result according to the generated plan to the electronic device 101 or transmit the generated plan to the electronic device 101. According to one or more embodiments, the electronic device 101 may display the result according to the plan on the display module 160. According to one or more embodiments, the electronic device 101 may display a result of executing an action according to the plan on the display module 160.

The intelligent server 200 of one or more embodiments may include a front end 210, a natural language platform 220, a capsule database (DB) 230, an execution engine 240, an end UI 250, a management platform 260, a big data platform 270, or an analytic platform 280.

The front end 210 may receive the received user input from the electronic device 101. The front end 210 may transmit a response corresponding to the user input.

According to one or more embodiments, the natural language platform 220 may include an automatic speech recognition (ASR) module 221, a natural language understanding (NLU) module 223, a planner module 225, a natural language generator (NLG) module 227, or a text-to-speech (TTS) module 229.

The ASR module 221 may convert the speech input received from the electronic device 101 into text data. The NLU module 223 may discern an intent of a user using the text data of the speech input. For example, the NLU module 223 may discern the intent of the user by performing syntactic analysis or semantic analysis on a user input in the form of text data. The NLU module 223 according to one or more embodiments may discern a meaning of a word extracted from the user input using a linguistic feature (e.g., a grammatical element) of a morpheme or a phrase, and may determine the intent of the user by matching the discerned meaning of the word to an intent. The NLU module 223 may obtain intent information corresponding to a user utterance. The intent information may be information indicating an intention of the user determined through an analysis of the text data. The intent information may include information indicating an action or function that the user intends to execute using a device.

The planner module 225 of one or more embodiments may generate a plan using a parameter and the intent determined by the NLU module 223. According to one or more embodiments, the planner module 225 may determine a plurality of domains required to perform a task based on the determined intent. The planner module 225 may determine a plurality of actions included in each of the plurality of domains determined based on the intent. According to one or more embodiments, the planner module 225 may determine a parameter required to execute the determined plurality of actions, or a result value output by the execution of the plurality of actions. The parameter and the result value may be defined as a concept of a designated form (or class). Accordingly, the plan may include a plurality of actions and a plurality of concepts determined by the intent of the user. The planner module 225 may determine relationships between the plurality of actions and the plurality of concepts stepwise (or hierarchically). For example, the planner module 225 may determine an execution order of the plurality of actions determined based on the intent of the user, based on the plurality of concepts. The planner module 225 may determine the execution order of the plurality of actions based on the parameter required for the execution of the plurality of actions and results output by the execution of the plurality of actions. Accordingly, the planner module 225 may generate a plan including connection information (e.g., ontology) on connections between the plurality of actions and the plurality of concepts. The planner module 225 may generate the plan using information stored in the capsule DB 230 that stores a set of relationships between concepts and actions.

The NLG module 227 may change designated information into a text form. The information changed to the text form may be in the form of a natural language utterance. The TTS module 229 may change information in a text form into information in a speech form.

According to one or more embodiments, some or all of the functions of the natural language platform 220 may be implemented in the electronic device 101 as well.

The capsule DB 230 may store information regarding the relationships between the plurality of concepts and actions corresponding to the plurality of domains. A capsule according to one or more embodiments may include a plurality of action objects (or action information) and concept objects (or concept information) included in the plan. According to one or more embodiments, the capsule DB 230 may store a plurality of capsules in the form of a concept action network (CAN). According to one or more embodiments, the plurality of capsules may be stored in a function registry included in the capsule DB 230.

The capsule DB 230 may include a strategy registry that stores strategy information necessary for determining a plan corresponding to a speech input. The strategy information may include reference information for determining one plan when a plurality of plans corresponding to the voice input are present. According to one or more embodiments, the capsule DB 230 may include a follow-up registry that stores information regarding follow-up actions for suggesting a follow-up action to the user in a designated situation. The follow-up action may include, for example, a follow-up utterance. According to one or more embodiments, the capsule DB 230 may include a layout registry that stores layout information that is information output through the electronic device 101. According to one or more embodiments, the capsule DB 230 may include a vocabulary registry that stores vocabulary information included in capsule information. According to one or more embodiments, the capsule DB 230 may include a dialog registry that stores information regarding a dialog (or an interaction) with the user. The capsule DB 230 may update the stored objects through a developer tool. The developer tool may include, for example, a function editor for updating an action object or a concept object. The developer tool may include a vocabulary editor for updating the vocabulary. The developer tool may include a strategy editor for generating and registering a strategy for determining a plan. The developer tool may include a dialog editor for generating a dialog with the user. The developer tool may include a follow-up editor for activating a follow-up objective and editing a follow-up utterance that provides a hint. The subsequent goal may be determined based on a currently configured goal, a preference of a user, or environmental conditions. In one or more embodiments, the capsule DB 230 may also be implemented within the electronic device 101.

The execution engine 240 may calculate a result using the generated plan. The end UI 250 may transmit the calculated result to the electronic device 101. Accordingly, the electronic device 101 may receive the result and provide the received result to the user. The management platform 260 may manage information used by the intelligent server 200. The big data platform 270 may collect data of the user. The analytic platform 280 may manage a quality of service (QoS) of the intelligent server 200. For example, the analytic platform 280 may manage the components and processing rate (or efficiency) of the intelligent server 200.

The service server 300 of one or more embodiments may include a CP service A 301, a CP service B 302, and a CP service C 303. The service server 300 of one or more embodiments may provide a designated service (e.g., food order or hotel reservation) to the electronic device 101. According to one or more embodiments, the service server 300 may be a server operated by a third party. The service server 300 may provide information to be used for generating a plan corresponding to the received user input to the intelligent server 200. The provided information may be stored in the capsule DB 230. In addition, the service server 300 may provide result information according to the plan to the intelligent server 200.

In the integrated intelligence system 10 described above, the electronic device 101 may provide various intelligent services to the user in response to a user input. The user input may include, for example, an input through a physical button, a touch input, or a speech input.

In one or more embodiments, the electronic device 101 may provide a speech recognition service through an intelligent app (or a speech recognition app) stored therein. In this case, for example, the electronic device 101 may recognize a user utterance or a speech input received through the microphone, and provide a service corresponding to the recognized speech input to the user.

In one or more embodiments, the electronic device 101 may perform a designated action alone or together with the intelligent server and/or a service server, based on the received speech input. For example, the electronic device 101 may execute an app corresponding to the received speech input and perform a designated action through the executed app.

In one or more embodiments, when the electronic device 101 provides a service together with the intelligent server 200 and/or the service server, the user terminal may detect a user utterance using the input module 150 and generate a signal (or speech data) corresponding to the detected user utterance. The user terminal may transmit the speech data to the intelligent server 200 using the interface 177.

The intelligent server 200 according to one or more embodiments may generate, as a response to the speech input received from the electronic device 101, a plan for performing a task corresponding to the speech input or a result of performing an action according to the plan. The plan may include, for example, a plurality of actions for performing a task corresponding to a speech input of a user, and a plurality of concepts related to the plurality of actions. The concepts may be defined as parameters that are input for execution of the plurality of actions or result values that are output by execution of the plurality of actions. The plan may include connection information regarding connections between the plurality of actions and the plurality of concepts.

The electronic device 101 of one or more embodiments may receive the response using the interface 177. The electronic device 101 may output a speech signal generated inside the electronic device 101 to the outside using the sound output module 155, or may output an image generated inside the electronic device 101 to the outside using the display module 160.

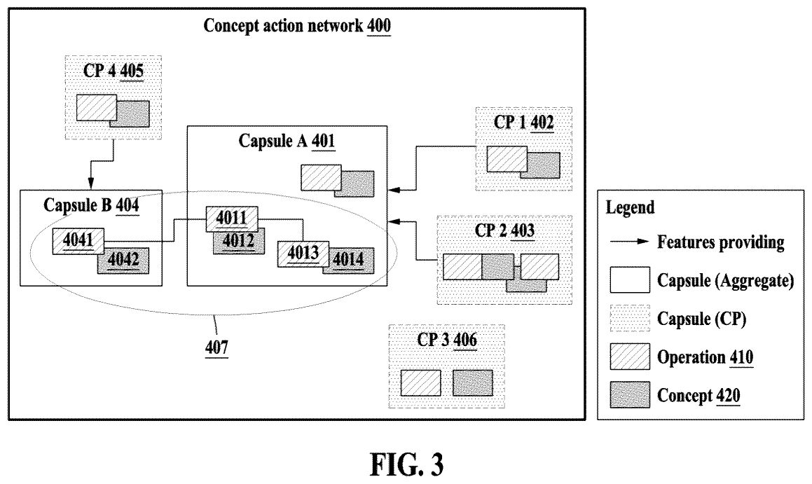

FIG. 3 is a diagram illustrating a form in which relationship information regarding relationships between concepts and actions is stored in a DB, according to various embodiments.

A capsule DB (e.g., the capsule DB 230 of FIG. 2) of the intelligent server (e.g., the intelligent server 200 of FIG. 2) may store capsules in the form of a CAN. The capsule DB may store an action for processing a task corresponding to a speech input of a user and a parameter necessary for the action in the form of a CAN.

The capsule DB may store a plurality of capsules (a capsule A 401 and a capsule B 404) respectively corresponding to a plurality of domains (e.g., applications). According to one or more embodiments, one capsule (e.g., the capsule A 401) may correspond to one domain (e.g., a location (geo) or an application). In addition, one capsule may correspond to at least one service provider (e.g., CP 1 402, CP 2 403, CP 3 406, or CP 4 405) for performing a function for a domain related to the capsule. According to one or more embodiments, one capsule may include at least one action 410 and at least one concept 420 to perform a designated function.

A natural language platform (e.g., the natural language platform 220 of FIG. 2) may generate a plan for performing a task corresponding to the received speech input using the capsules stored in the capsule DB. For example, a planner module (e.g., the planner module 225 of FIG. 2) of the natural language platform may generate a plan using the capsules stored in the capsule DB. For example, a plan 407 may be generated using actions 4011 and 4013 and concepts 4012 and 4014 of the capsule A 410 and an action 4041 and a concept 4042 of the capsule B 404.

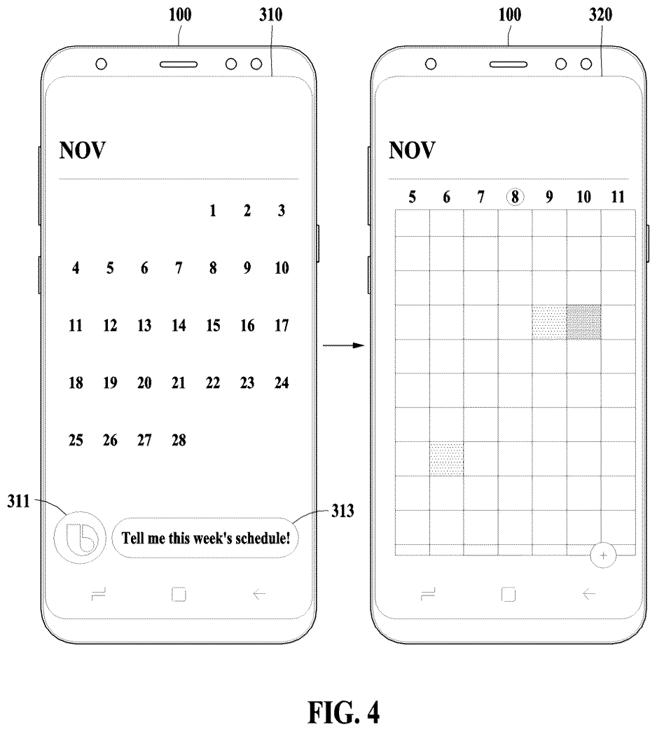

FIG. 4 is a diagram illustrating a screen of a user terminal processing a received speech input through an intelligent app, according to various embodiments.

The electronic device 101 may execute an intelligent app to process a user input through an intelligent server (e.g., the intelligent server 200 of FIG. 2).

According to one or more embodiments, on a screen 310, when a designated speech input (e.g., Wake up!) is recognized or an input through a hardware key (e.g., a dedicated hardware key) is received, the electronic device 101 may execute an intelligent app for processing the speech input. The electronic device 101 may execute the intelligent app, for example, in a state in which a scheduling app is executed. According to one or more embodiments, the electronic device 101 may display an object (e.g., an icon) 311 corresponding to the intelligent app on the display module 160. According to one or more embodiments, the electronic device 101 may receive a speech input by a user utterance. For example, the electronic device 101 may receive a speech input of “Tell me this week's schedule!”. According to one or more embodiments, the electronic device 101 may display a UI 313 (e.g., an input window) of the intelligent app in which text data of the received speech input is displayed on a display module (e.g., the display module 160 of FIG. 2).

According to one or more embodiments, on a screen 320, the electronic device 101 may display a result corresponding to the received speech input on the display module 160. For example, the electronic device 101 may receive a plan corresponding to the received user input, and display “this week's schedule” on the display module 160 according to the plan.

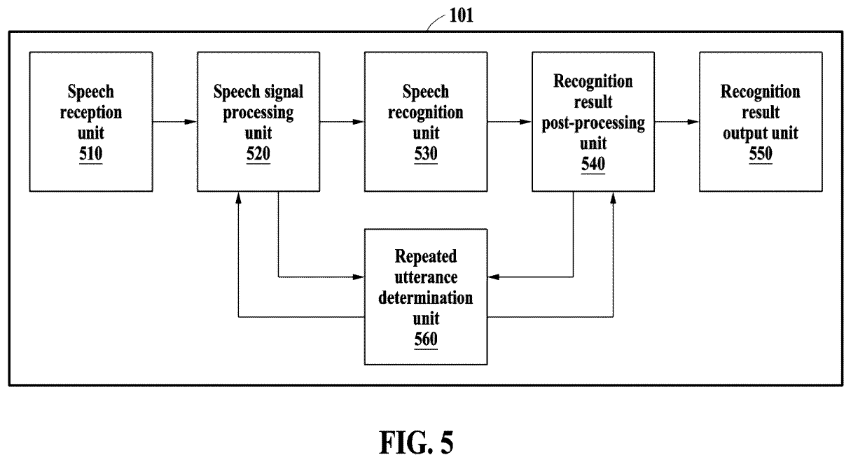

FIG. 5 is a schematic block diagram illustrating an electronic device 101 according to various embodiments.

Referring to FIG. 5, the electronic device 101 according to various embodiments may include a speech reception unit 510, a speech signal processing unit 520, a speech recognition unit 530, a recognition result post-processing unit 540, a recognition result output unit 550, and a repeated utterance determination unit 560.

As illustrated in FIG. 5, the electronic device 101 may include the speech reception unit 510, the speech signal processing unit 520, the speech recognition unit 530, the recognition result post-processing unit 540, the recognition result output unit 550, and the repeated utterance determination unit 560, each of which includes processing circuitry (e.g., the processor 120 of FIG. 1) and/or memory (e.g., the memory 130 of FIG. 1), but embodiments are not limited thereto. For example, as illustrated in FIG. 5, the electronic device 101 may perform substantially the same functions and/or operations as those of the speech reception unit 510, the speech signal processing unit 520, the speech recognition unit 530, the recognition result post-processing unit 540, the recognition result output unit 550, and the repeated utterance determination unit 560 by using the processor 120 and/or the memory 130.

The electronic device 101 may receive a first utterance and a second utterance from a user through the speech reception unit 510 (e.g., the input module 150 or a microphone of FIG. 1). For example, the second utterance may refer to an utterance received from the user within a set time after the first utterance is received, after a recognition result of the first utterance is provided, or after an operation is performed based on the recognition result of the first utterance.

For example, the electronic device 101 may determine the identity of a user who uttered the received utterance. The electronic device 101 may determine whether the second utterance is a repeated utterance when it is determined that the first utterance and the second utterance are uttered by the same user.

The received first utterance and/or the received second utterance may be stored in an audio buffer.

The electronic device 101 may process the received first utterance and/or the received second utterance stored in the audio buffer by using the speech signal processing unit 520. The speech signal processing unit 520 may process the first utterance and/or the second utterance using parameters for speech signal processing, and may determine speech features corresponding to the first utterance and speech features corresponding to the second utterance.

The electronic device 101 may determine a recognition result of the first utterance and/or a recognition result of the second utterance using the speech recognition unit 530. Hereinafter, when the second utterance is determined to be a repeated utterance, an operation of correcting and/or determining a recognition result of the second utterance will be described. However, the electronic device 101 may apply the operation of correcting and/or determining the recognition result of the second utterance to the first utterance in substantially the same manner.

In an example, the electronic device 101 may correct a recognition result of the first utterance and/or a recognition result of the second utterance using the recognition result post-processing unit 540. For example, the recognition result post-processing unit 540 may correct a recognition result of the first utterance and/or a recognition result of the second utterance based on parameters for correcting a recognition result of the first utterance and/or a recognition result of the second utterance.

In an example, the electronic device 101 may output a corrected recognition result of the first utterance and/or a corrected recognition result of the second utterance using the recognition result output unit 550. For example, the electronic device 101 may provide a user with a corrected recognition result of the first utterance and/or a corrected recognition result of the second utterance. For example, the electronic device 101 may provide a recognition result via a display module (e.g., the display module 160 of FIG. 1).

The electronic device 101 may provide a corrected recognition result of the first utterance and/or a corrected recognition result of the second utterance to another device, a server, and/or a service.

In an example, the electronic device 101 may determine a similarity between the first utterance and the second utterance using the repeated utterance determination unit 560. In an example, the electronic device 101 may determine a first similarity between a recognition result of the first utterance and a recognition result of the second utterance using the repeated utterance determination unit 560.

For example, the electronic device 101 may determine a similarity between the first utterance and the second utterance based on speech signal information of the first utterance and speech signal information of the second utterance. For example, speech signal information may include energy of a signal, a speech rate, a noise level, and an endpoint of a speech segment.

For example, speech signal information of the first utterance may be stored in the memory 130 (e.g., a cache), for a set time after the first utterance is received. When the second utterance is received within a set time after the first utterance is received, the electronic device 101 may determine a similarity between speech signal information of the first utterance stored in the memory 130 and speech signal information of the second utterance.

In an example, the electronic device 101 may determine a similarity between speech signal information of the first utterance and speech signal information of the second utterance in terms of signal similarity. For example, the electronic device 101 may determine a similarity using cross-correlation and a spectrogram of speech signal information of the first utterance and speech signal information of the second utterance. The electronic device 101 may determine a similarity using various types of information included in speech signal information of the first utterance and speech signal information of the second utterance, and parameters for determining the similarity are not limited to the foregoing examples.

In an example, when a similarity between speech signal information of the first utterance and speech signal information of the second utterance is greater than or equal to a set threshold, the electronic device 101 may determine parameters for processing speech signal information of the second utterance. For example, the electronic device 101 may determine parameters for processing a speech signal of the second utterance that have values different from parameters for processing a speech signal of the first utterance.

In an example, the speech signal processing unit 520 may process the second utterance based on the determined parameters. For example, the electronic device 101 may determine parameters based on an energy level of the second utterance relative to an energy level of the first utterance and a set energy level. The speech signal processing unit 520 may increase or decrease an energy level of a speech signal of the second utterance based on the determined parameters.

For example, when an energy level of the first utterance is about 50, an energy level of a speech signal of the second utterance is about 60, and performance of speech recognition increases as an energy level approaches 100, the electronic device 101 may determine parameters such that the energy level of the speech signal of the second utterance approaches 100. The speech signal processing unit 520 may process the second utterance based on the determined parameters such that an energy level of the second utterance approaches 100. The speech signal processing unit 520 may process the second utterance based on the determined parameters such that an energy level of the second utterance is amplified.

For example, the electronic device 101 may determine parameters for processing the second utterance based on a signal-to-noise ratio (SNR). For example, when a set SNR is 20 dB, an SNR of the first utterance is about 0 dB, and an SNR of the second utterance is about 3 dB, the electronic device 101 may determine parameters such that the SNR of the second utterance is about 20 dB.

For example, the electronic device 101 may perform noise removal on the second utterance using noise information of the first utterance.

In the foregoing examples, the electronic device 101 has been described as determining parameters for processing the second utterance based on an energy level and/or an SNR of the second utterance. However, the electronic device 101 is not limited to the foregoing examples and may determine parameters for determining various speech signal features of the second utterance. For example, the electronic device 101 may determine parameters for determining speech signal features such as a speech rate and a speech segment of the second utterance. The speech signal processing unit 520 may process the second utterance based on the determined parameters to amplify or reduce an energy level of the second utterance, determine an SNR of the second utterance, or determine a speech rate and a speech segment of the second utterance.

In an example, the electronic device 101 may determine a first similarity between a recognition result of the first utterance and a recognition result of the second utterance using the repeated utterance determination unit 560. The electronic device 101 may determine the first similarity in terms of character similarity between a recognition result of the first utterance and a recognition result of the second utterance. Hereinafter, a recognition result of the first utterance may refer to a corrected recognition result that is output from the recognition result output unit 550 after the electronic device 101 processes the first utterance. For ease of description, a corrected recognition result corresponding to the first utterance that is output from the recognition result output unit 550 may be described as a recognition result of the first utterance.

For example, the repeated utterance determination unit 560 may determine the first similarity based on keywords and a format of a recognition result of the first utterance and a recognition result of the second utterance.

For example, when a recognition result of the first utterance is “Call Cutie” and a recognition result of the second utterance is “Call Cute”, the repeated utterance determination unit 560 may determine the first similarity based on a degree of similarity between the keywords “Cutie” and “Cute”.

For example, when a recognition result of the first utterance is “Call Cutie” and a recognition result of the second utterance is “Call Cute”, the repeated utterance determination unit 560 may determine the first similarity based on a degree of similarity of a format “Call ˜” of the recognition results.

For example, when a recognition result of the first utterance is “Call Cutie” and a recognition result of the second utterance is “Call Cute”, the repeated utterance determination unit 560 may determine the first similarity based on a degree of similarity between the recognition result of the first utterance and the recognition result of the second utterance as a whole.

In an example, when the first similarity is greater than or equal to the set threshold, the electronic device 101 may determine parameters for correcting a recognition result of the second utterance. For example, parameters for correcting a recognition result may include an edit distance for correcting an entity name included in a recognition result of the second utterance.

For example, when a first utterance and a second utterance of a user are “Call Kutie” and recognition results of the first utterance and the second utterance are “Call Cute”, the electronic device 101 may increase an edit distance by a set amount. For example, when a set edit-distance threshold is 1 and an edit distance between the entity names “Cute” and “Kutie” is 2, the recognition result post-processing unit 54 may not correct “Cute” to “Kutie”, because the edit distance between “Cute” and “Kutie” exceeds the set edit-distance threshold.

When a recognition result of the first utterance and a recognition result of the second utterance are “Call Cute”, the electronic device 101 may identify that the second utterance is a repeated utterance of the first utterance by the user. The electronic device 101 may identify that the second utterance is a repeated utterance of the first utterance when the first similarity is greater than or equal to the set threshold. The electronic device 101 may increase an edit-distance correction threshold.

In the foregoing examples, when the edit-distance threshold is increased to 2, the recognition result post-processing unit 540 may correct a recognition result of the second utterance to “Call Kutie”.

In an example, the electronic device 101 may correct a recognition result of the second utterance based on data stored in the memory 130 or a personal database (PD). For example, when a recognition result of the first utterance and a recognition result of the second utterance are “Call Cute” and a determined edit-distance threshold is 2, the recognition result post-processing unit 540 may correct a recognition result of the second utterance to an entity name, among entity names stored in the PD, that has an edit distance of 2 or less from “Cute”. The determined edit-distance threshold may be obtained by increasing a set edit-distance threshold or an initial edit-distance value (e.g., 1) by a set amount (e.g., 1). For example, when an entity name “Kutie” is stored in the PD and an edit distance between “Cute” and “Kutie” is 2, the recognition result post-processing unit 540 may correct a recognition result of the second utterance to “Call Kutie”.

In an example, the electronic device 101 may correct a recognition result of the second utterance differently from a recognition result of the first utterance based on the determined parameters. For example, when a recognition result of the first utterance and a recognition result of the second utterance are “Call Cute”, a determined edit distance is 2, and the entity names “Cute” and “Kutie” are stored in the PD, the electronic device 101 may correct a recognition result of the second utterance to “Call Kutie”. Although an entity name “Cute” that is identical to an entity name “Cute” included in a recognition result of the second utterance (e.g., an edit distance of 0) is stored in the PD, because “Call Cute” is identical to a recognition result of the first utterance, the recognition result post-processing unit 540 may correct a recognition result of the second utterance to “Call Kutie”.

In an example, the electronic device 101 may determine a second similarity between a corrected recognition result of the second utterance and a recognition result of the first utterance. When the second similarity is greater than or equal to the set threshold, the electronic device 101 may correct candidate recognition results of the second utterance based on the parameters. The electronic device 101 may determine, from among corrected candidate recognition results, a recognition result that is different from a recognition result of the first utterance as a recognition result of the second utterance.

For example, a plurality of candidate recognition results of the second utterance may be present. Hereinafter, for ease of description, candidate recognition results of the second utterance are assumed to include a first-ranked candidate “Call Cute”, a second-ranked candidate “Call Cutie”, a third-ranked candidate “Call Kutie”, and a fourth-ranked candidate “Call Kute”.

For example, when a recognition result of the first utterance is “Call Cute” and a determined edit distance is 2, the electronic device 101 may correct the first-ranked candidate “Call Cute” based on the determined edit distance. For example, when an edit distance between the entity names “Cute” and “Kutie” stored in the PD is 3, the electronic device 101 may determine and/or correct a recognition result of the second utterance to “Call Cute”.

The electronic device 101 may determine the second similarity between a corrected recognition result of the second utterance and a recognition result of the first utterance. Since the recognition result of the corrected second utterance is the same as the recognition result of the first utterance, the second similarity may be greater than or equal to the set threshold.

When the second similarity is greater than or equal to the set threshold, the electronic device 101 may correct candidate recognition results of the second utterance based on the determined parameters (e.g., a determined edit distance). For example, the recognition result post-processing unit 540 may correct the second-ranked candidate “Call Cutie” based on entity names stored in the PD and the determined edit distance. For example, when an edit distance between “Cutie” and “Kutie” is less than or equal to 2, and the entity name “Kutie” is stored in the PD, the recognition result post-processing unit 540 may correct the second-ranked candidate “Call Cutie” to “Call Kutie”.

The recognition result post-processing unit 540 may correct the third-ranked candidate “Call Kutie” and the fourth-ranked candidate “Call Kute” in substantially the same manner as correcting the first-ranked candidate and/or the second-ranked candidate, based on entity names stored in the PD and the determined parameters.

In an example, the electronic device 101 may determine, from among corrected candidate recognition results, a recognition result that is different from a recognition result of the first utterance as a recognition result of the second utterance. For example, when the first-ranked candidate is corrected to “Call Cute”, the second-ranked candidate is corrected to “Call Kutie”, the third-ranked candidate is corrected to “Call Kutie”, and the fourth-ranked candidate is corrected to “Call Kutie” by the recognition result post-processing unit 540, the electronic device 101 may determine the corrected second-ranked candidate “Call Kutie” as a recognition result of the second utterance. Since the corrected first-ranked candidate is the same as the recognition result of the first utterance “Call Cute”, the electronic device 101 may determine, as a recognition result of the second utterance, the corrected second-ranked candidate “Call Kutie” that is different from the recognition result of the first utterance and has the highest priority.

In an example, the electronic device 101 may determine the candidate with the highest priority among the corrected candidates as the recognition result of the second utterance. For example, when the first-ranked candidate is corrected to “Call Cute”, the second-ranked candidate is corrected to “Call Cute”, the third-ranked candidate is corrected to “Call Kutie”, and the fourth-ranked candidate is corrected to “Call Kutie” by the recognition result post-processing unit 540, the electronic device 101 may determine the corrected third-ranked candidate “Call Kutie” as a recognition result of the second utterance. Since the corrected first-ranked candidate and the corrected second-ranked candidate are the same as the recognition result of the first utterance “Call Cute”, the electronic device 101 may determine, as a recognition result of the second utterance, the corrected third-ranked candidate “Call Kutie” that is different from the recognition result of the first utterance and has the highest priority.

In the foregoing examples, the electronic device 101 has been described with reference to one or more embodiments in which the second similarity is determined using a corrected recognition result of the second utterance and a recognition result of the first utterance, but embodiments are not limited thereto. For example, the electronic device 101 may receive a third utterance within a set time after receiving the second utterance. The electronic device 101 may determine the second similarity using a corrected recognition result of the third utterance and a recognition result of the first utterance. When the second similarity determined using a corrected recognition result of the third utterance and a recognition result of the first utterance is greater than or equal to the set threshold, the electronic device 101 may correct candidate recognition results of the third utterance. The electronic device 101 may determine, from among corrected candidate recognition results, a recognition result that is different from a recognition result of the first utterance as a recognition result of the third utterance.

In an example, when the first similarity determined between a recognition result of the first utterance and a recognition result of the second utterance is greater than or equal to the set threshold, the electronic device 101 may determine parameters for correcting a recognition result of the second utterance. For example, the electronic device 101 may increase a set edit distance (e.g., 1) by a set amount (e.g., 1). The determined parameters may be initialized to the set edit distance when no subsequent utterance is received within the set time.

For example, when the first similarity between a recognition result of the second utterance and a recognition result of the first utterance is greater than or equal to the set threshold, the electronic device 101 may increase the set edit distance from 1 to 2. For example, when a third utterance is not received within a set time after a second utterance is received or after a recognition result of the second utterance is output, the electronic device 101 may initialize a (determined) edit distance to 1 (or initialize parameters). For example, when the first similarity between a recognition result of the third utterance received within the set time after the second utterance is received and a recognition result of the first utterance (and/or a recognition result of the second utterance) is less than the set threshold, the electronic device 101 may initialize the (determined) edit distance to 1. For example, when the first similarity between a recognition result of the third utterance received within the set time after the second utterance is received and a recognition result of the first utterance (and/or a recognition result of the second utterance) is greater than or equal to the set threshold, the electronic device 101 may increase the (determined) edit distance from 2 to 3.

The recognition result output unit 550 may output a corrected recognition result of the second utterance (or the third utterance), or a corrected candidate that is determined as a recognition result of the second utterance (or the third utterance).

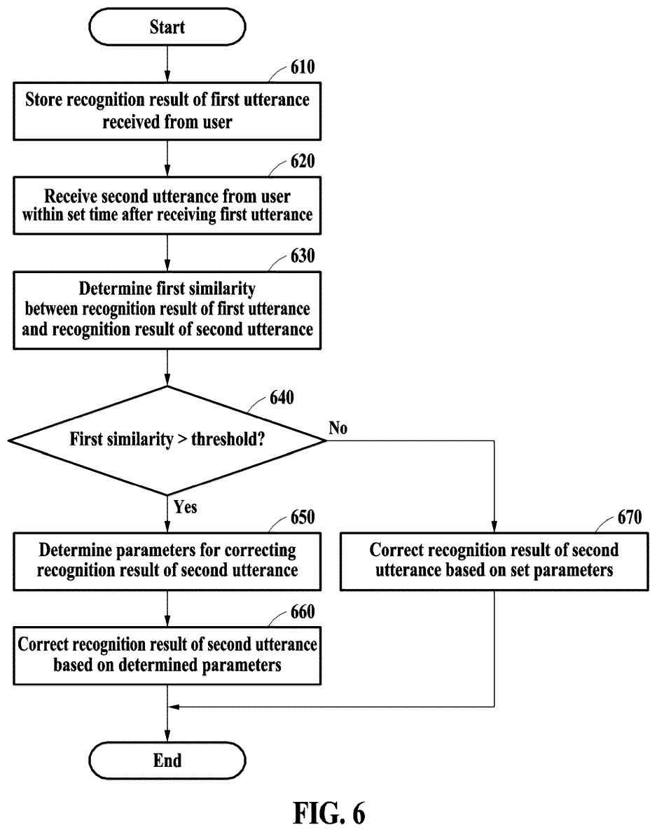

FIG. 6 is a flowchart illustrating an operation of a speech signal processing method according to various embodiments.

In the following embodiments, operations may be performed sequentially but not necessarily. For example, the order of the operations may be changed and at least two of the operations may be performed in parallel.

According to one or more embodiments, operations 610 to 670 may be performed by a processor 120 (e.g., the processor 120 of FIGS. 1 and 2) of an electronic device 101 (e.g., the electronic device 101 of FIGS. 1, 2, and 5).

In an example, in operation 610, the electronic device 101 may store a recognition result of a first utterance received from a user. For example, the recognition result of the first utterance may represent a recognition result output, in response to the received first utterance, from a recognition result output unit (e.g., the recognition result output unit 550 of FIG. 5) of the electronic device 101.

In an example, in operation 620, the electronic device 101 may receive a second utterance from the user within a set time after receiving the first utterance. For example, in operation 620, the electronic device 101 may receive the second utterance within the set time after outputting the recognition result of the first utterance.

In an example, in operation 630, the electronic device 101 may determine a first similarity between the recognition result of the first utterance and a recognition result of the second utterance. For example, the electronic device 101 may determine the first similarity in terms of a character similarity. The electronic device 101 may determine the first similarity based on at least one of an entirety, keywords, and a format of the recognition result of the first utterance and the recognition result of the second utterance.

The electronic device 101 may compare at least one of an entirety, keywords, and a format of the recognition result of the first utterance and the recognition result of the second utterance using various known methods, and may determine a degree of similarity between the recognition result of the first utterance and the recognition result of the second utterance.

For example, the first similarity may represent a degree of similarity between the recognition result of the first utterance and the recognition result of the second utterance.

In an example, in operation 640, the electronic device 101 may determine whether the first similarity is greater than or equal to a threshold.

In an example, when it is determined in operation 640 that the first similarity is greater than or equal to the threshold, the electronic device 101 may determine, in operation 650, parameters for correcting the recognition result of the second utterance. For example, the parameters for correcting the recognition result of the second utterance may include an edit distance. The edit distance may refer to a parameter for correcting an entity name included in a recognition result to another entity name (e.g., an entity name stored in a PD). As the edit distance increases, the electronic device 101 may correct an entity name included in the recognition result to another entity name having a greater difference from the entity name included in the recognition result.

For example, when an entity name included in the recognition result is “Cute” and the edit distance is 1, the electronic device 101 may not correct the entity name to “Kutie”, whereas when the edit distance is 2, the electronic device 101 may correct the entity name to “Kutie”.

In the foregoing examples, the edit distance between entity names is merely illustrative. The electronic device 101 may determine an edit distance between other entity names (or words) different from those in the foregoing examples, and the edit distance between entity names in the foregoing examples may be determined differently.

For example, in operation 650, the electronic device 101 may increase a set edit distance (e.g., 1) by a set amount (e.g., 1). When no subsequent utterance is input within the set time after the recognition result of the second utterance is output (or after the second utterance is received), the increased (or determined) edit distance may be initialized.

In an example, in operation 660, the electronic device 101 may correct the recognition result of the second utterance based on the determined parameters. For example, the electronic device 101 may correct the recognition result of the second utterance based on data or a PD stored in a memory (e.g., memory 130 of FIG. 1). For example, the electronic device 101 may correct the recognition result of the second utterance differently from the recognition result of the first utterance.

In an example, when it is determined in operation 640 that the first similarity is less than the threshold, the electronic device 101 may correct the recognition result of the second utterance in operation 670 based on set parameters (or initial parameters).

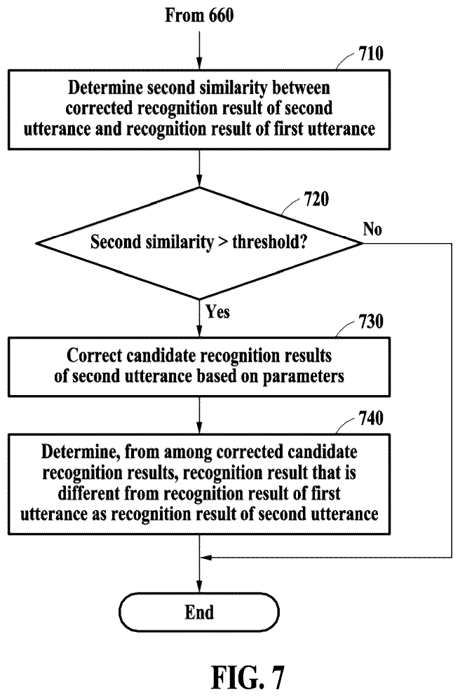

FIG. 7 is a flowchart illustrating an operation of determining a recognition result of a second utterance using candidate recognition results of the second utterance according to various embodiments.

In the following embodiments, operations may be performed sequentially but not necessarily. For example, the order of the operations may be changed and at least two of the operations may be performed in parallel.

According to one or more embodiments, operations 710 to 740 may be being performed by a processor 120 (e.g., the processor 120 of FIGS. 1 and 2) of an electronic device 101 (e.g., the electronic device 101 of FIGS. 1, 2, and 5).

In an example, after operation 660, the electronic device 101 may determine, in operation 710, a second similarity between a corrected recognition result of the second utterance and a recognition result of a first utterance. For example, the electronic device 101 may determine a second similarity between a corrected recognition result of the second utterance and a recognition result of the first utterance, substantially in the same manner as operation 630 of FIG. 6 (determining a first similarity between the recognition result of the first utterance and the recognition result of the second utterance).

In an example, in operation 720, the electronic device 101 may determine whether the second similarity is greater than or equal to a set threshold.

In an example, when the second similarity is greater than or equal to the set threshold in operation 720, the electronic device 101 may correct candidate recognition results of the second utterance based on the parameters in operation 730. For example, the electronic device 101 may generate a set number of candidate recognition results of the second utterance. The candidate recognition results of the second utterance may be prioritized based on a probability of matching the second utterance received from a user.

When the second similarity is greater than or equal to the set threshold, the electronic device 101 may correct candidate recognition results of the second utterance (e.g., a second-ranked candidate, a third-ranked candidate, and a fourth-ranked candidate) based on determined parameters in operation 730.

In an example, in operation 740, the electronic device 101 may determine, from among corrected candidate recognition results, a recognition result that is different from a recognition result of the first utterance as a recognition result of the second utterance. For example, when a corrected second-ranked candidate and a corrected third-ranked candidate are the same as a recognition result of the first utterance (or a corrected recognition result of the second utterance), the electronic device 101 may determine a corrected fourth-ranked candidate as the recognition result of the second utterance.

In an example, the electronic device 101 may determine a third similarity by comparing the corrected candidates with a recognition result of the first utterance (or a corrected recognition result of the second utterance). The electronic device 101 may determine, as a recognition result of the second utterance, a corrected candidate having the highest priority among corrected candidates whose third similarity is less than the set threshold.

In the foregoing examples, thresholds for comparison with the first similarity, the second similarity, and the third similarity may be set to different values or may be set to the same value.

In an example, when the second similarity is less than the set threshold in operation 720, the electronic device 101 may output a corrected recognition result of the second utterance.

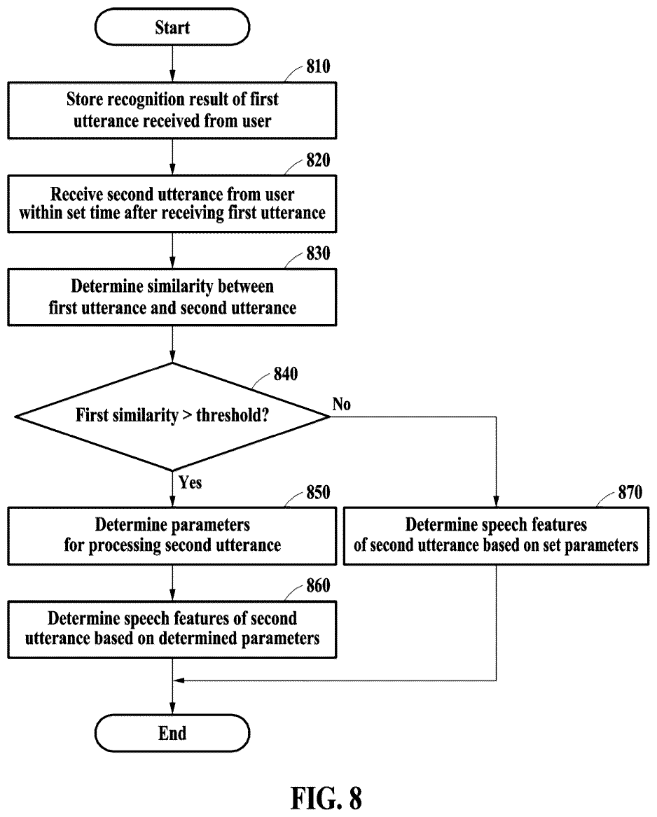

FIG. 8 is a flowchart illustrating an operation of a speech signal processing method according to various embodiments.

In the following embodiments, operations may be performed sequentially but not necessarily. For example, the order of the operations may be changed and at least two of the operations may be performed in parallel.

According to one or more embodiments, operations 810 to 870 may be being performed by a processor 120 (e.g., the processor 120 of FIGS. 1 and 2) of an electronic device 101 (e.g., the electronic device 101 of FIGS. 1, 2, and 5).

In an example, in operation 810, the electronic device 101 may store a first utterance received from a user.

In an example, in operation 820, the electronic device 101 may receive a second utterance from the user within a set time after receiving the first utterance.

The descriptions of operations 610 and 620 of FIG. 6 may apply operations 810 and 820 described above, respectively, in substantially the same manner.

In an example, in operation 830, the electronic device 101 may determine a similarity between the first utterance and the second utterance. In operation 830, the electronic device 101 may determine a similarity based on a signal similarity of a speech signal.

For example, the electronic device 101 may determine a similarity based on speech signal information of the first utterance and speech signal information of the second utterance. Speech signal information may include signal energy, a speech rate, a noise level, and an endpoint of a speech segment.

In operation 830, the electronic device 101 may determine a similarity between the first utterance and the second utterance using various speech signal information, without limitation to the foregoing examples. In operation 830, the electronic device 101 may determine a similarity between a speech signal of the first utterance and a speech signal of the second utterance using various known methods.

In an example, in operation 840, the electronic device 101 may determine whether a similarity is greater than or equal to a set threshold.

In an example, when it is determined in operation 840 that the similarity is greater than or equal to the set threshold, the electronic device 101 may determine, in operation 850, parameters for processing the second utterance. The electronic device 101 may process the first utterance and/or the second utterance based on parameters to determine speech features of the first utterance and/or speech features of the second utterance.

In an example, in operation 850, the electronic device 101 may determine parameters for processing the second utterance differently from parameters (e.g., initially set parameters) for processing the first utterance.

In an example, in operation 860, the electronic device 101 may determine speech features of the second utterance based on determined parameters.

For example, when speech signal information of the first utterance is the same as speech signal information of the second utterance, parameters for processing the second utterance may be determined to be different from parameters for processing the first utterance. When parameters for processing the second utterance are different from parameters for processing the first utterance, speech features of the second utterance may be different from speech features of the first utterance, even when speech signal information of the first utterance is the same as speech signal information of the second utterance.

For example, when parameters for processing the second utterance are different from parameters for processing the first utterance, an energy level and an SNR of the second utterance may be determined to be different from an energy level and an SNR of the first utterance, even when speech signal information of the first utterance is the same as speech signal information of the second utterance.

In an example, when it is determined in operation 840 that the similarity is less than the set threshold, the electronic device 101 may determine speech features of the second utterance based on set parameters in operation 870.

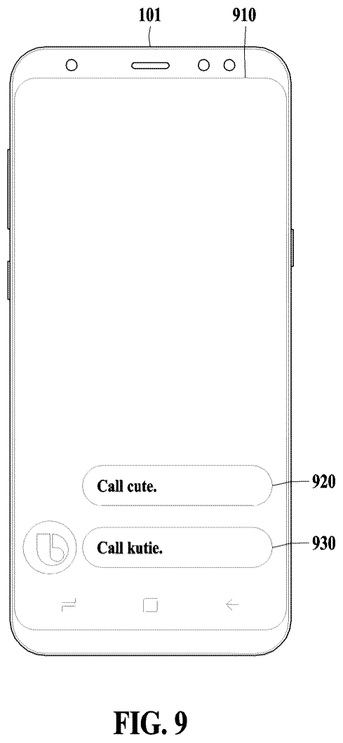

FIG. 9 is a diagram illustrating a screen on which an electronic device 101 (e.g., the electronic device 101 of FIGS. 1 and 2) according to various embodiments provides a recognition result 920 of a first utterance and a recognition result 930 of a corrected second utterance.

As illustrated in FIG. 9, the electronic device 101 may display a screen 910 through a display included in a display module (e.g., the display module 160 of FIG. 1).

For example, the recognition result 920 of a first utterance and a recognition result of a second utterance may be “Call Cute” The electronic device 101 may determine parameters for correcting the second utterance when a first similarity between the recognition result 920 of the first utterance and the recognition result of the second utterance is greater than or equal to a set threshold. The electronic device 101 may correct the recognition result of the second utterance to “Call Kutie” based on the determined parameters.

As illustrated in FIG. 9, the electronic device 101 may display the recognition result 920 of the first utterance and a recognition result 930 of a corrected second utterance on a display and provide the recognition results to a user.

In an example, the electronic device 101 may perform an operation based on at least one of the recognition result 920 of the first utterance and the recognition result 930 of the corrected second utterance, based on input (e.g., touch) received from the user. For example, when the user selects the recognition result 920 of the first utterance, the electronic device 101 may connect a call to a contact named “Cute” stored in a PD. For example, when the user selects the recognition result 930 of the corrected second utterance, the electronic device 101 may connect a call to a contact named “Kutie” stored in the PD.

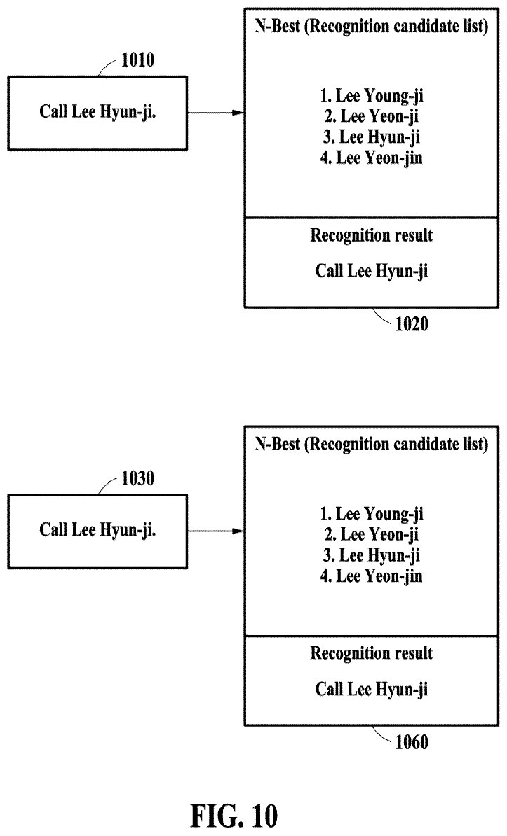

FIG. 10 is a diagram illustrating an operation of an electronic device (e.g., the electronic device 101 of FIGS. 1 and 5) according to various embodiments for correcting candidate recognition results of a second utterance based on parameters.

For example, a first utterance 1010 may be “Call Lee Hyun-ji”, and a recognition result of the first utterance 1010 may be “Call Lee Young-ji”. Entity names stored in a PD (or a personal data sync service (PDSS)) may be “Lee Hyun-ji” or “Lee Yeon-ji”.

For example, a first-ranked candidate for a recognition result of the first utterance 1010 may be “Call Lee Young-ji”, a second-ranked candidate may be “Call Lee Yeon-ji”, a third-ranked candidate may be “Call Lee Hyun-ji”, and a fourth-ranked candidate may be “Call Lee Yeon-jin”. When a set edit distance is 1, an edit distance between an entity name “Lee Hyun-ji” stored in a PD and an entity name “Lee Young-ji” is 2, and an edit distance between an entity name “Lee Yeon-ji” stored in the PD and an entity name “Lee Young-ji” is 1, the electronic device 101 may determine a (corrected) recognition result 1020 of the first utterance as “Call Lee Yeon-ji”, which has the highest priority and the smallest edit distance between an entity name of the recognition result and an entity name stored in the PD.

When a second utterance 1030 is “Call Lee Hyun-ji”, a first-ranked candidate for a recognition result of the second utterance may be “Call Lee Young-ji”, a second-ranked candidate may be “Call Lee Yeon-ji”, a third-ranked candidate may be “Call Lee Hyun-ji”, and a fourth-ranked candidate may be “Call Lee Yeon-jin”.

Based on a similarity between the (corrected) recognition result 1020 of the first utterance (“Call Lee Yeon-ji”) and the recognition result of the second utterance (or a first-ranked recognition result “Call Lee Yeon-ji”), the electronic device 101 may increase an edit distance to 2.

For example, the electronic device 101 may correct the first-ranked candidate “Call Lee Young-ji” for the recognition result of the second utterance to “Call Lee Yeon-ji” based on the set edit distance of 1. In FIG. 10, the first-ranked recognition result of the second utterance may be “Call Lee Yeon-ji”.

For example, the electronic device 101 may determine a similarity by comparing the corrected recognition result 1020 of the first utterance (“Call Lee Yeon-ji”) with the first-ranked recognition result of the second utterance (“Call Lee Yeon-ji”).

Since the corrected recognition result 1020 of the first utterance (“Call Lee Yeon-ji”) is the same as a corrected first-ranked recognition result of the second utterance (“Call Lee Yeon-ji”), a similarity may be greater than or equal to a set threshold. When the corrected recognition result 1020 of the first utterance (“Call Lee Yeon-ji”) is the same as the corrected first-ranked recognition result of the second utterance (“Call Lee Yeon-ji”), the electronic device 101 may increase the set edit distance by a set amount of 1.

The edit distance between the entity name “Lee Young-ji” and the entity name “Lee Hyun-ji” stored in the PDSS may be 2, and the edit distance between the entity name “Lee Young-ji” and the entity name “Lee Yeon-ji” stored in the PDSS may be 1. When a determined edit distance is 2, the electronic device 101 may correct (or determine) an entity name (“Lee Young-ji”) included in the first-ranked candidate of the second utterance to an entity name (“Lee Yeon-ji”) stored in the PDSS (e.g., an entity name having the smallest edit distance among entity names stored in the PDSS). The electronic device 101 may correct (or determine) the first-ranked recognition result of the second utterance as “Call Lee Yeon-ji”.

The edit distance between the entity name “Lee Yeon-ji” and the entity name “Lee Hyun-ji” stored in the PDSS may be 1, and the edit distance between the entity name “Lee Yeon-ji” and the entity name “Lee Yeon-ji” stored in the PDSS may be 0. When a determined edit distance is 2, the electronic device 101 may correct (or determine) an entity name (“Lee Yeon-ji”) included in the second-ranked candidate of the second utterance to an entity name (“Lee Yeon-ji”) stored in the PDSS (e.g., an entity name having the smallest edit distance among entity names stored in the PDSS). The electronic device 101 may correct (or determine) a second-ranked recognition result of the second utterance as “Call Lee Yeon-ji”.

The edit distance between the entity name “Lee Hyun-ji” and the entity name “Lee Hyun-ji” stored in the PDSS may be 0, and the edit distance between the entity name “Lee Yeon-ji” and the entity name “Lee Yeon-ji” stored in the PDSS may be 1. When a determined edit distance is 2, the electronic device 101 may correct (or determine) an entity name (“Lee Hyun-ji”) included in the third-ranked candidate of the second utterance to an entity name (“Lee Hyun-ji”) stored in the PDSS (e.g., an entity name having the smallest edit distance among entity names stored in the PDSS). The electronic device 101 may correct (or determine) a third-ranked recognition result of the second utterance as “Call Lee Hyun-ji”.

The edit distance between the entity name “Lee Yeon-jin” and the entity name “Lee Hyun-ji” stored in the PDSS may be 1, and the edit distance between the entity name “Lee Yeon-ji” and the entity name “Lee Yeon-ji” stored in the PDSS may be 0. When a determined edit distance is 2, the electronic device 101 may correct (or determine) an entity name (“Lee Yeon-jin”) included in the fourth-ranked candidate of the second utterance to an entity name (“Lee Yeon-ji”) stored in the PDSS (e.g., an entity name having the smallest edit distance among entity names stored in the PDSS). The electronic device 101 may correct (or determine) a fourth-ranked recognition result of the second utterance as “Call Lee Yeon-ji”.

In the foregoing example, when the edit distance is 2, the electronic device 101 may determine the first-ranked recognition result, the second-ranked recognition result, and the fourth-ranked recognition result of the second utterance as “Call Lee Yeon-ji” and may determine the third-ranked recognition result of the second utterance as “Call Lee Hyun-ji”.

In an example, the electronic device 101 may determine, from among candidate recognition results of the second utterance, a recognition result that is different from the corrected recognition result 1020 of the first utterance as a corrected recognition result 1060 of the second utterance.

For example, in the foregoing example, since the first-ranked recognition result, the second-ranked recognition result, and the fourth-ranked recognition result (“Call Lee Yeon-ji”) of the second utterance are the same as the corrected recognition result 1020 of the first utterance, and the third-ranked recognition result (“Call Lee Hyun-ji”) of the second utterance is different from the corrected recognition result 1020 of the first utterance, the electronic device 101 may determine the third-ranked recognition result of the second utterance, “Call Lee Hyun-ji”, as the corrected recognition result 1040 of the second utterance.

In an example, the electronic device 101 may determine, from among candidate recognition results of the second utterance, a candidate recognition result having a highest priority among recognition results different from the corrected recognition result 1020 of the first utterance as a corrected recognition result 1060 of the second utterance.

For example, when the corrected recognition result of the first utterance is “Call Lee Yeon-ji”, and the first-ranked recognition result and the fourth-ranked recognition result of the second utterance are “Call Lee Yeon-ji”, the second-ranked recognition result of the second utterance is “Call Lee Hyun-ji”, and the third-ranked recognition result of the second utterance is “Call Lee Young-ji”, the electronic device 101 may determine, as the corrected recognition result of the second utterance, the second-ranked recognition result of the second utterance, which is different from the corrected recognition result of the first utterance and has a higher priority than the third-ranked recognition result.

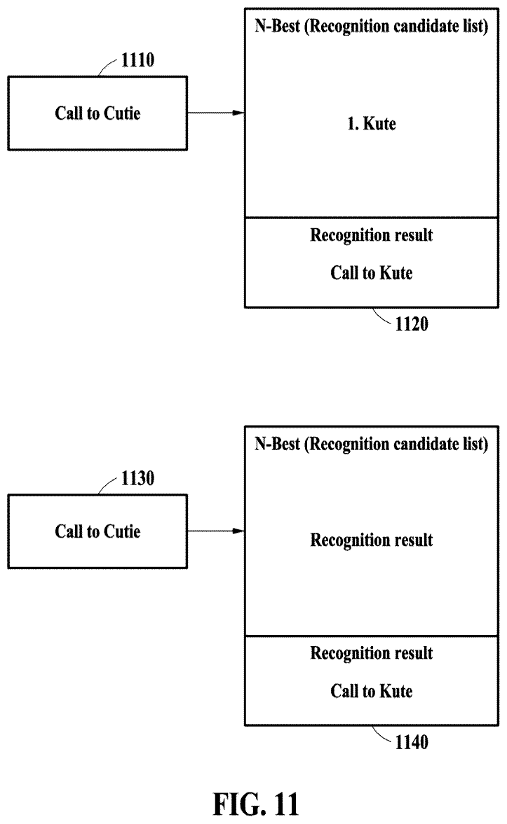

FIG. 11 is a diagram illustrating an operation of an electronic device (e.g., the electronic device 101 of FIGS. 1 and 5) according to various embodiments for correcting candidate recognition results of a second utterance based on parameters.

In FIG. 11, a first utterance 1110 may be “Call to Cutie”, and a second utterance 1130 may be “Call to Cutie”. For example, entity names stored in a PDSS may include “Cutie”, “Cote”, and “Kutie”.

The electronic device 101 may correct a recognition result of a first utterance, “Call to Kute”, based on correction parameters and entity names stored in the PDSS.

For example, an edit distance between the entity name “Kute” and each of the entity names “Cutie”, “Cote”, and “Kutie” stored in a PD may be 2.

Since no entity name having an edit distance of 1 or less from the entity name “Kute” included in the recognition result of the first utterance is stored in the PDSS, the electronic device 101 may correct (or determine) the recognition result of the first utterance as “Call to Kute”. In FIG. 11, a corrected recognition result 1120 of the first utterance may be “Call to Kute”.

When a recognition result of the second utterance is “Call to Kute”, the electronic device 101 may determine a first similarity between the corrected recognition result 1120 of the first utterance and the recognition result of the second utterance. Since the corrected recognition result 1120 of the first utterance (“Call to Kute”) is the same as the recognition result of the second utterance (“Call to Kute”), the electronic device 101 may increase an edit distance to 2 based on a second similarity.

When a plurality of entity names (e.g., “Cutie”, “Cote”, and “Kutie”) having an edit distance of 2 or less from the entity name “Kute” included in the recognition result of the second utterance are stored in the PDSS, the electronic device 101 may provide, to a user, the recognition result of the second utterance in which the plurality of entity names are corrected or may provide the plurality of entity names, as illustrated in FIG. 11. Based on a user selection, the electronic device 101 may determine the recognition result of the second utterance. For example, the electronic device 101 may display, on a display module, the recognition result of the second utterance corrected with a plurality of entity names (e.g., “Call to Cutie”, “Call to Cote”, and “Call to Kutie”) or a plurality of entity names (e.g., “Cutie”, “Cote”, and “Kutie”).

The electronic device 101 may receive, from the user, an input for selecting one of the recognition result of the second utterance corrected with the plurality of entity names or the plurality of entity names. For example, when an input for selecting “Call to Kute” or “Kute” is received from the user, the electronic device 101 may correct (or determine) a recognition result 1140 of the second utterance as “Call to Kute”.

An electronic device 101 according to various embodiments includes a processor 120 and a memory 130 electrically coupled to the processor 120 and storing instructions executable by the processor 120. The processor 120, when the instructions are executed, may store a recognition result of a first utterance received from a user. The processor 120 may receive a second utterance from the user within a set time after receiving the first utterance. The processor 120 may determine a first similarity between the recognition result of the first utterance and a recognition result of the second utterance. The processor 120 may determine parameters for correcting the recognition result of the second utterance when the first similarity is greater than or equal to a set threshold. The processor 120 may correct the recognition result of the second utterance based on the parameters.

The processor 120 may determine a second similarity between the corrected recognition result of the second utterance and the recognition result of the first utterance. The processor 120 may correct candidate recognition results of the second utterance based on the parameters when the second similarity is greater than or equal to the set threshold. The processor 120 may determine, from among the corrected candidate recognition results, a recognition result different from the recognition result of the first utterance as the recognition result of the second utterance.

The processor 120 may determine, from among the corrected candidate recognition results, a candidate recognition result having the highest priority as the recognition result of the second utterance.

The processor 120 may correct the recognition result of the second utterance based on data stored in the memory 130.

The processor 120 may provide the user with the recognition result of the first utterance and the corrected recognition result of the second utterance. The processor 120 may perform an operation in response to input received from the user.

The processor 120 may increase an edit distance for correcting an entity name included in the recognition result of the second utterance.

The processor 120 may determine the first similarity based on keywords and a format of the recognition result of the first utterance and the recognition result of the second utterance.

An electronic device 101 according to various embodiments includes a processor 120 and a memory 130 electrically coupled to the processor 120 and storing instructions executable by the processor 120. The processor 120, when the instructions are executed, may store a first utterance received from a user. The processor 120 may receive a second utterance from the user within a set time after receiving the first utterance. The processor 120 may determine a similarity between the first utterance and the second utterance. The processor 120 may determine parameters for processing the second utterance when the similarity is greater than or equal to a set threshold. The processor 120 may determine speech features of the second utterance based on the parameters.

The processor 120 may determine the similarity based on speech signal information of the first utterance and speech signal information of the second utterance.

The processor 120 may process, based on the parameters, at least one of an energy level of the second utterance, an SNR, and a speech rate of the second utterance, and determine speech features of the second utterance.

A speech signal processing method according to various embodiments includes storing a recognition result of a first utterance received from a user, receiving a second utterance from the user within a set time after receiving the first utterance, determining a first similarity between the recognition result of the first utterance and a recognition result of the second utterance, determining parameters for correcting the recognition result of the second utterance when the first similarity is greater than or equal to a set threshold, and correcting the recognition result of the second utterance based on the parameters.

The speech signal processing method may further include determining a second similarity between the corrected recognition result of the second utterance and the recognition result of the first utterance. The speech signal processing method may further include correcting candidate recognition results of the second utterance based on the parameters when the second similarity is greater than or equal to the set threshold. The speech signal processing method may further include determining, from among the corrected candidate recognition results, a recognition result different from the recognition result of the first utterance as the recognition result of the second utterance.

The determining of the recognition result of the second utterance may include determining, from among the corrected candidate recognition results, a candidate recognition result having the highest priority as the recognition result of the second utterance.

The correcting of the recognition result of the second utterance may include correcting the recognition result of the second utterance based on data stored in a memory 130.

The speech signal processing method may further include providing the user with the recognition result of the first utterance and the corrected recognition result of the second utterance. The speech signal processing method may further include performing an operation in response to input received from the user.

The determining of the parameters for correcting the recognition result of the second utterance may include increasing an edit distance for correcting an entity name included in the recognition result of the second utterance.

The determining of the first similarity may include determining the first similarity based on keywords and a format of the recognition result of the first utterance and the recognition result of the second utterance.

A speech signal processing method according to various embodiments includes storing a first utterance received from a user, receiving a second utterance from the user within a set time after receiving the first utterance, determining a similarity between the first utterance and the second utterance, determining parameters for processing the second utterance when the similarity is greater than or equal to a set threshold, and determining speech features of the second utterance based on the parameters.

A non-transitory computer-readable storage medium according to various embodiments may store instructions that, when executed by a processor, cause the processor to perform the speech signal processing method.

The electronic device according to various embodiments may be one of various types of electronic devices. The electronic device may include, for example, a portable communication device (e.g., a smartphone), a computer device (e.g., tablet PC, laptop, desktop), a portable multimedia device, a portable medical device, a camera, a wearable device (e.g., Smartwatch), kiosk, gaming consoles, Smart speakers, voice controlled-robots, or a home appliance device (e.g., Smart TV). According to one or more embodiments, the electronic device is not limited to those described above.

According to one or more embodiments, instructions stored in memory of an electronic device, when executed by the one or more processors individually or collectively, may further cause the electronic device to determine a second similarity between the corrected recognition result of the second utterance and the recognition result of the first utterance; when the second similarity is greater than or equal to the threshold, correct candidate recognition results of the second utterance based on the parameters; and determine that a recognition result different from the recognition result of the first utterance is the recognition result of the second utterance based on the corrected candidate recognition results.

The instructions, when executed by the one or more processors individually or collectively, may further cause the electronic device to determine that a candidate recognition result having the highest priority is the recognition result of the second utterance based on the corrected candidate recognition results.

The instructions, when executed by the one or more processors individually or collectively, may further cause the electronic device to correct the recognition result of the second utterance based on data stored in the memory.

The instructions, when executed by the one or more processors individually or collectively, may further cause the electronic device to provide, to the user, the recognition result of the first utterance and the corrected recognition result of the second utterance; and perform an operation in response to an input received from the user.

The instructions, when executed by the one or more processors individually or collectively, may further cause the electronic device to increase an edit distance for correcting an entity name included in the recognition result of the second utterance.

The instructions, when executed by the one or more processors individually or collectively, may further cause the electronic device to determine the first similarity based on keywords and a format of the recognition result of the second utterance and the recognition result of the first utterance.

The method for processing the speech signal may further include determining a second similarity between the corrected recognition result of the second utterance and the recognition result of the first utterance; when the second similarity is greater than or equal to the threshold, correcting candidate recognition results of the second utterance based on the parameters; and determining that a recognition result different from the recognition result of the first utterance is the recognition result of the second utterance based on the corrected candidate recognition results.

The determining of the recognition result of the second utterance may include determining that a candidate recognition result having the highest priority is the recognition result of the second utterance based on the corrected candidate recognition results.

The correcting of the recognition result of the second utterance may include correcting the recognition result of the second utterance based on data stored in memory.

The method may further include providing, to the user, the recognition result of the first utterance and the corrected recognition result of the second utterance; and performing an operation in response to an input received from the user.

The determining of the parameters for correcting the recognition result of the second utterance may include increasing an edit distance for correcting an entity name included in the recognition result of the second utterance.

The determining of the first similarity may include determining the first similarity based on keywords and a format of the recognition result of the second utterance and the recognition result of the first utterance.

The instructions stored in the non-transitory computer-readable storage medium, when executed by the one or more processors of the electronic device, may further cause the electronic device to determine a second similarity between the corrected recognition result of the second utterance and the recognition result of the first utterance; when the second similarity is greater than or equal to the threshold, correct candidate recognition results of the second utterance based on the parameters; and determine that a recognition result different from the recognition result of the first utterance is the recognition result of the second utterance based on the corrected candidate recognition results.

The instructions stored in the non-transitory computer-readable storage medium, when executed by the one or more processors of the electronic device, may further cause the electronic device to determine that a candidate recognition result having the highest priority is the recognition result of the second utterance based on the corrected candidate recognition results.

The instructions stored in the non-transitory computer-readable storage medium, when executed by the one or more processors of the electronic device, may further cause the electronic device to correct the recognition result of the second utterance based on data stored in the memory.

The instructions stored in the non-transitory computer-readable storage medium, when executed by the one or more processors of the electronic device, may further cause the electronic device to provide, to the user, the recognition result of the first utterance and the corrected recognition result of the second utterance; and perform an operation in response to an input received from the user.

The instructions stored in the non-transitory computer-readable storage medium, when executed by the one or more processors of the electronic device, may further cause the electronic device to increase an edit distance for correcting an entity name included in the recognition result of the second utterance.

Other variations are within the spirit of the present disclosure. While the disclosed techniques are susceptible to various modifications and alternative constructions, certain illustrated embodiments are shown in the drawings and described above in detail. However, there is no intention to limit the disclosure to the specific forms disclosed. Rather, the intention is to cover all modifications, alternative constructions, and equivalents falling within the spirit and scope of the disclosure as defined in the appended claims. With regard to the description of the drawings, similar reference numerals may be used to refer to similar or related components. The terms “a,” “an,” “the,” and similar referents in the context of describing the disclosed embodiments (especially in the claims) are to be construed to cover both singular and plural forms, unless otherwise indicated or clearly contradicted by context. The number of items in a plurality is at least two, but may be more when indicated explicitly or by context. The terms “first,” “second,” “third,” and the like in the description and in the claims, if any, are used for distinguishing between similar elements and not necessarily for describing a sequential or chronological order. It is to be understood that the terms so used are interchangeable under appropriate circumstances.

It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., by wire), wirelessly, or via a third component.

Further, unless stated otherwise or otherwise clear from context, phrase “based on” may refer to “based at least in part on” and not “based solely on.”

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

As used in connection with various embodiments of the disclosure, terms such as “units” “modules” or any other nominalized verbs may be implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one or more embodiments, the module may be implemented in a form of an ASIC and/or field-programmable gate array (FPGA). In other examples, those may be implemented or embodied by analog and/or digital circuits. These circuits may include one or more of a logic gate, an integrated circuit, a microprocessor, a microcontroller, a memory circuit, a passive electronic component, an active electronic component, an optical component, and the like. Alternatively or additionally, these components may be implemented or embodied by software comprising one or more instructions stored in an internal or external storage medium that is readable by at least one processor. For example, the at least one processor may invoke at least one of the one or more instructions stored in the storage medium and execute it, with or without using one or more other components under the control of the at least one processor. This allows the at least one processor to perform at least one function or operation described above as being performed by each of the components according to the at least one instruction invoked. The at least one processor may include a central processing unit (CPU), a graphics processing unit (GPU), or another type of microprocessor, without limitation.

Various embodiments as set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one or more embodiments, a method according to various embodiments of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one among the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
one or more processors; and
memory storing instructions,
wherein the instructions, when executed by the one or more processors individually or collectively, cause the electronic device to:
store a recognition result of a first utterance received from a user;
receive a second utterance from the user within a period after receiving the first utterance;
determine a first similarity between the recognition result of the first utterance and a recognition result of the second utterance;
determine parameters for correcting the recognition result of the second utterance based on the first similarity being greater than or equal to a threshold; and
correct the recognition result of the second utterance based on the parameters.

2. The electronic device of claim 1, wherein the instructions, when executed by the one or more processors individually or collectively, further cause the electronic device to:
determine a second similarity between the corrected recognition result of the second utterance and the recognition result of the first utterance;
when the second similarity is greater than or equal to the threshold, correct candidate recognition results of the second utterance based on the parameters; and
determine that a recognition result different from the recognition result of the first utterance is the recognition result of the second utterance based on the corrected candidate recognition results.

3. The electronic device of claim 2, wherein the instructions, when executed by the one or more processors individually or collectively, further cause the electronic device to:
determine that a candidate recognition result having the highest priority is the recognition result of the second utterance based on the corrected candidate recognition results.

4. The electronic device of claim 1, wherein the instructions, when executed by the one or more processors individually or collectively, further cause the electronic device to:
correct the recognition result of the second utterance based on data stored in the memory.

5. The electronic device of claim 1, wherein the instructions, when executed by the one or more processors individually or collectively, further cause the electronic device to:
provide, to the user, the recognition result of the first utterance and the corrected recognition result of the second utterance; and
perform an operation in response to an input received from the user.

6. The electronic device of claim 1, wherein the instructions, when executed by the one or more processors individually or collectively, further cause the electronic device to:
increase an edit distance for correcting an entity name included in the recognition result of the second utterance.

7. The electronic device of claim 1, wherein the instructions, when executed by the one or more processors individually or collectively, further cause the electronic device to:
determine the first similarity based on keywords and a format of the recognition result of the second utterance and the recognition result of the first utterance.

8. A method for processing a speech signal, the method comprising:
storing a recognition result of a first utterance received from a user;
receiving a second utterance from the user within a period after receiving the first utterance;
determining a first similarity between the recognition result of the first utterance and a recognition result of the second utterance;
determining parameters for correcting the recognition result of the second utterance based on the first similarity being greater than or equal to a threshold; and
correcting the recognition result of the second utterance based on the parameters.

9. The method of claim 8, further comprising:
determining a second similarity between the corrected recognition result of the second utterance and the recognition result of the first utterance;
when the second similarity is greater than or equal to the threshold, correcting candidate recognition results of the second utterance based on the parameters; and
determining that a recognition result different from the recognition result of the first utterance is the recognition result of the second utterance based on the corrected candidate recognition results.

10. The method of claim 9, wherein the determining of the recognition result of the second utterance comprises:
determining that a candidate recognition result having the highest priority is the recognition result of the second utterance based on the corrected candidate recognition results,.

11. The method of claim 8, wherein the correcting of the recognition result of the second utterance comprises:
correcting the recognition result of the second utterance based on data stored in memory.

12. The method of claim 8, further comprising:
providing, to the user, the recognition result of the first utterance and the corrected recognition result of the second utterance; and
performing an operation in response to an input received from the user.

13. The method of claim 8, wherein the determining of the parameters for correcting the recognition result of the second utterance comprises:
increasing an edit distance for correcting an entity name included in the recognition result of the second utterance.

14. The method of claim 8, wherein the determining of the first similarity comprises:
determining the first similarity based on keywords and a format of the recognition result of the second utterance and the recognition result of the first utterance.

15. A non-transitory computer-readable storage medium having stored thereon instructions that, when executed by one or more processors of an electronic device individually or collectively, cause the electronic device to:
store a recognition result of a first utterance received from a user;
receive a second utterance from the user within a period after receiving the first utterance;
determine a first similarity between the recognition result of the first utterance and a recognition result of the second utterance;
determine parameters for correcting the recognition result of the second utterance based on the first similarity being greater than or equal to a threshold; and
correct the recognition result of the second utterance based on the parameters.

16. The non-transitory computer-readable storage medium of claim 15, wherein the instructions, when executed by the one or more processors of the electronic device, further cause the electronic device to:
determine a second similarity between the corrected recognition result of the second utterance and the recognition result of the first utterance;
when the second similarity is greater than or equal to the threshold, correct candidate recognition results of the second utterance based on the parameters; and
determine that a recognition result different from the recognition result of the first utterance is the recognition result of the second utterance based on the corrected candidate recognition results.

17. The non-transitory computer-readable storage medium of claim 16, wherein the instructions, when executed by the one or more processors of the electronic device, further cause the electronic device to:
determine that a candidate recognition result having the highest priority is the recognition result of the second utterance based on the corrected candidate recognition results.

18. The non-transitory computer-readable storage medium of claim 15, wherein the instructions, when executed by the one or more processors of the electronic device, further cause the electronic device to:
correct the recognition result of the second utterance based on data stored in the memory.

19. The non-transitory computer-readable storage medium of claim 15, wherein the instructions, when executed by the one or more processors of the electronic device, further cause the electronic device to:
provide, to the user, the recognition result of the first utterance and the corrected recognition result of the second utterance; and
perform an operation in response to an input received from the user.

20. The non-transitory computer-readable storage medium of claim 15, wherein the instructions, when executed by the one or more processors of the electronic device, further cause the electronic device to:
increase an edit distance for correcting an entity name included in the recognition result of the second utterance.
